(19) United States
(12) Patent Application Publication
(10) Pub. No.: US 2024/0337751 A1
(43) Pub. Date: Oct. 10, 2024

(54) IMAGING DEVICE AND IMAGING METHOD

(71) Applicant: JVCKENWOOD Corporation, Yokohama-shi (JP)

(72) Inventor: Hiroshi YOSHIKAWA, Yokohama-shi (JP)

(21) Appl. No.: 18/749,356

(22) Filed: Jun. 20, 2024

Related U.S. Application Data
(63) Continuation of application No. PCT/JP2022/037825, filed on Oct. 11, 2022.

(30) Foreign Application Priority Data
Dec. 23, 2021 (JP) 2021-209780
Dec. 23, 2021 (JP) 2021-209786
Dec. 23, 2021 (JP) 2021-209795

(51) Int. Cl. G01S 17/894; G01S 7/481; G01S 7/4865

(52) U.S. Cl. CPC G01S 17/894; G01S 7/4815; G01S 7/4865

(57) ABSTRACT

An imaging device includes a first light source that emits first irradiation light that is light having a first wavelength, a second light source that emits second irradiation light that is light having a second wavelength different from the first wavelength, a first detection unit that detects first reflected light that is reflected light of the first irradiation light with which a target object is irradiated, a second detection unit that detects second reflected light that is reflected light of the second irradiation light with which the target object is irradiated, and an optical member that transmits part of the light reflected by the target object to guide the first reflected light to the first detection unit, and reflects part of the light reflected by the target object to guide the second reflected light to the second detection unit.

### TECHNICAL FIELD

The present invention relates to an imaging device and an imaging method.

### CROSS REFERENCE TO RELATED APPLICATION

Priority is claimed on Japanese Patent Application No. 2021-209780, Japanese Patent Application No. 2021-209786, and Japanese Patent Application No. 2021-209795 filed Dec. 23, 2021, the content of which is incorporated herein by reference.

### BACKGROUND ART

In the related art, there is a technology for measuring a distance to a target object by irradiating the target object with laser diode light having a predetermined wavelength, receiving light reflected by the target object, and analyzing the received light (for example, see Patent Document 1).

### CITATION LIST

### Patent Document

### [Patent Document 1]

Japanese Unexamined Patent Application, First Publication No. 2021-18079

### SUMMARY OF INVENTION

### Technical Problem

However, the specific wavelength of laser diode light used for distance measurement may be attenuated by a sunlight spectrum that reaches a surface of the Earth. Further, with a wavelength other than the specific wavelength, it is possible to avoid the attenuation due to the sunlight spectrum, but there is a problem that a transmittance or spectral sensitivity of an image sensor is degraded indoors where there is no influence of a solar spectrum.

That is, according to the related art, since a suitable wavelength of the laser diode light used for distance measurement is different between indoors and outdoors, there is, for example, a problem that it is not possible to accurately measure the distance to a target object when a measurement environment changes.

Further, it is conceivable to accurately measure the distance to the target object using the laser diode light beams with different wavelengths in order to solve this problem. However, there is a problem in that the laser diode light beams with different wavelengths interfere with each other.

Furthermore, it is preferable to dispose a light source near an optical axis in order to reduce a distance measurement error due to an angular difference, for measurement at a short distance. On the other hand, when the light source is disposed near the optical axis, there is a problem in that a shadow of irradiation is generated on a side surface of the target object. That is, when a plurality of light sources are disposed, there is a problem that the distance to the target object cannot be accurately measured depending on the disposition.

The present invention has been made in view of these circumstances, and an object of the present invention is to provide (1) a technology capable of accurately measuring the distance to a target object even in a plurality of different environments, (2) a technology capable of measuring the distance to the target object using laser diode light beams with different wavelengths without an interference between the laser diode light beams, and (3) a technology capable of accurately measuring the distance to the target object using laser diode light beams with different wavelengths.

### Solution to Problem

An imaging device according to an aspect of the present embodiment includes a first light source configured to emit first irradiation light, the first irradiation light being light having a first wavelength; a second light source configured to emit second irradiation light, the second irradiation light being light having a second wavelength different from the first wavelength; a first detection unit configured to detect first reflected light, the first reflected light being reflected light of the first irradiation light with which a target object is irradiated; a second detection unit configured to detect second reflected light, the second reflected light being reflected light of the second irradiation light with which the target object is irradiated; and an optical member configured to transmit part of the light reflected by the target object to guide the first reflected light to the first detection unit, and reflect part of the light reflected by the target object to guide the second reflected light to the second detection unit.

Further, an imaging method according to an aspect of the present embodiment includes a first irradiation step of emitting first irradiation light, the first irradiation light being light having a first wavelength; a second irradiation step of emitting second irradiation light, the second irradiation light being light having a second wavelength different from the first wavelength; a first detection step of detecting, by a first detection unit, the first reflected light being reflected light of the first irradiation light with which a target object is irradiated; a second detection step of detecting, by a second detection unit, the second reflected light being reflected light of the second irradiation light with which the target object is irradiated; and a step of transmitting the first reflected light to guide the first reflected light to the first detection unit and reflecting the second reflected light to guide the second reflected light to the second detection unit.

An imaging device according to an aspect of the present embodiment includes a first light source configured to emit first irradiation light, the first irradiation light being light having a first wavelength; a second light source configured to emit second irradiation light, the second irradiation light being light having a second wavelength different from the first wavelength; a first detection unit configured to detect first reflected light, the first reflected light being reflected light of the first irradiation light with which a target object is irradiated; and a second detection unit configured to detect second reflected light, the second reflected light being reflected light of the second irradiation light with which the target object is irradiated, wherein a first period in which the first light source emits the first irradiation light and the first detection unit detects the first reflected light does not overlap a second period in which the second light source emits the second irradiation light and the second detection unit detects the second reflected light.

Further, an imaging method according to an aspect of the present embodiment includes a first irradiation step of emitting first irradiation light, the first irradiation light being light having a first wavelength; a second irradiation step of emitting second irradiation light, the second irradiation light being light having a second wavelength different from the first wavelength; a first detection step of detecting, by a first detection unit, the first reflected light being reflected light of the first irradiation light with which a target object is irradiated; and a second detection step of detecting, by a second detection unit, the second reflected light being reflected light of the second irradiation light with which the target object is irradiated; wherein a first period in which the first irradiation light is emitted in the first irradiation step and the first reflected light is detected in the first detection step does not overlap a second period in which the second irradiation light is emitted in the second irradiation step and the second reflected light is detected in the second detection step.

An imaging device according to an aspect of the present embodiment includes a first light source configured to emit first irradiation light, the first irradiation light being light having a first wavelength; a second light source configured to emit second irradiation light, the second irradiation light being light having a second wavelength different from the first wavelength; a first detection unit configured to detect first reflected light, the first reflected light being reflected light of the first irradiation light with which a target object is irradiated; and a second detection unit configured to detect second reflected light, the second reflected light being reflected light of the second irradiation light with which the target object is irradiated, wherein the second light source is disposed at a position closer to the optical axis than the first light source is.

Further, an imaging method according to an aspect of the present embodiment includes a first irradiation step of emitting, by a first light source, first irradiation light having a first wavelength; a second irradiation step of emitting, by a second light source, second irradiation light, the second irradiation light being light having a second wavelength different from the first wavelength; a first detection step of detecting first reflected light, the first reflected light being reflected light of the first irradiation light with which a target object is irradiated; and a second detection step of detecting second reflected light, the second reflected light being reflected light of the second irradiation light with which the target object is irradiated, wherein the second light source is disposed at a position closer to the optical axis than the first light source is.

### Advantageous Effects of Invention

According to the present embodiment, (1) it is possible to (1) accurately measure the distance to the target object even in a plurality of different environments, (2) to measure the distance to the target object using the laser diode light beams with different wavelengths, or (3) to accurately measure the distance to the target object using the laser diode light beams with different wavelengths.

### BRIEF DESCRIPTION OF DRAWINGS

FIG. 1 is a diagram illustrating an overview of an imaging device according to Embodiment 1.

FIG. 2 is a schematic diagram showing an example of a cross section of the imaging device according to Embodiment 1.

FIG. 3 is a diagram illustrating an imaging device according to Modification Example 1 of Embodiment 1.

FIG. 4 is a diagram illustrating an imaging device according to Modification Example 2 of Embodiment 1.

FIG. 5 is a diagram illustrating an imaging device according to Modification Example 3 of Embodiment 1.

FIG. 6 is a diagram illustrating an imaging device according to Modification Example 4 of Embodiment 1.

FIG. 7 is a diagram illustrating effects when a RGB sensor and a ToF sensor have the same number of pixels and the same angle of view in the imaging device according to Embodiment 1.

FIG. 8 is a diagram illustrating effects when the numbers of pixels and field angle matching parameters of the RGB sensor and the ToF sensor are known in the imaging device according to Embodiment 1.

FIG. 9 is a diagram illustrating sharing of distortion correction values in the imaging device according to Embodiment 1.

FIG. 10 is a diagram illustrating sharing of surrounding light decrease correction data in the imaging device according to Embodiment 1.

FIG. 11 is a diagram illustrating sharing of chromatic aberration correction data in the imaging device according to Embodiment 1.

FIG. 12 is a diagram illustrating an interference between near-infrared light beams with two different wavelengths according to Embodiment 2.

FIG. 13 is a timing chart showing an example of an operation period of irradiation and exposure of laser light according to Embodiment 2.

FIG. 14 is a diagram illustrating a problem that an imaging device attempts to solve in Embodiment 3.

FIG. 15 is a diagram illustrating an example of indoor distance measurement according to Embodiment 3.

FIG. 16 is a diagram illustrating an example of outdoor distance measurement according to Embodiment 3.

FIG. 17 is a schematic diagram showing an example of a disposition of light sources according to Embodiment 3.

FIG. 18 is a schematic diagram showing an example of a disposition of light sources according to a modification example of Embodiment 3.

### DESCRIPTION OF EMBODIMENTS

Hereinafter, embodiments of the present invention will be described with reference to the drawings. The embodiments to be described below are merely examples, and embodiments to which the present invention is applied are not limited thereto.

“On the basis of XX” as used herein means “based on at least XX”, and includes “based on other elements in addition to XX”. “On the basis of XX” is not limited to a case where XX is used directly, but also includes “based on a result of performing calculation or processing on XX”. “XX” is an arbitrary element (for example, arbitrary information).

Furthermore, in the following description, a posture of the imaging device 10 may be indicated by a three-dimensional orthogonal coordinate system of an x-axis, a y-axis, and a z-axis.

### Embodiment 1

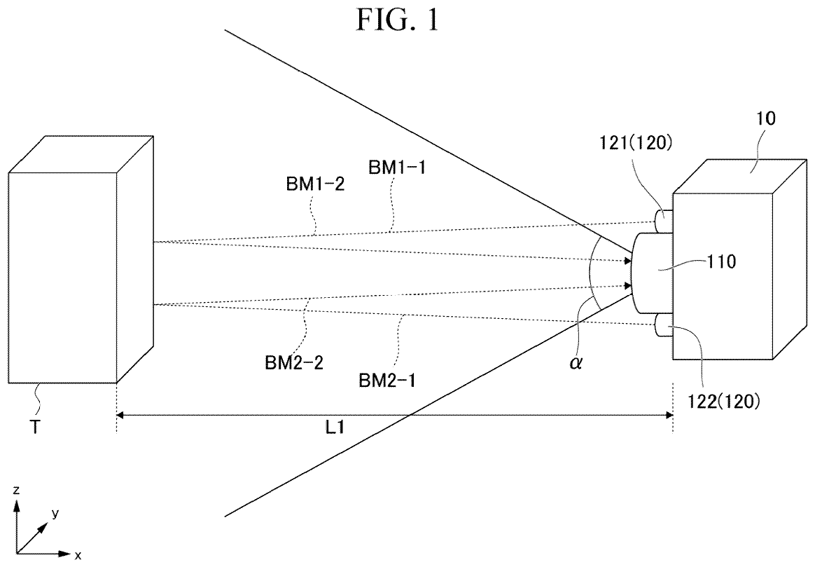

FIG. 1 is a diagram illustrating an overview of an imaging device according to Embodiment 1. The overview of the imaging device 10 will be described with reference to FIG. 1.

The imaging device 10 measures a distance L1 to a target object T present in a three-dimensional space. The imaging device 10 may measure the distance L1 to the target object T outdoors where there is an influence of a sunlight spectrum, or may measure the distance L1 to the target object T indoors where there is no influence of the sunlight spectrum.

The imaging device 10 includes a lens 110, a laser diode 120, and a sensor (not shown). The lens 110 may be, for example, an objective lens. The laser diode 120 is a light source that irradiates the target object T with irradiation light having a predetermined wavelength. The irradiation light emitted by the laser diode 120 is reflected by the target object T and is incident on the lens 110. The sensor receives the reflected light reflected by the target object T via the lens 110. The imaging device 10 measures the distance from the imaging device 10 to the target object T by analyzing the received reflected light.

The imaging device 10 may include a plurality of laser diodes 120. Further, irradiation light emitted by the plurality of laser diodes 120 included in the imaging device 10 may have different wavelengths. When the imaging device 10 includes the plurality of laser diodes 120 that emit irradiation light beams with different wavelengths, the laser diode 120 that emits first irradiation light BM1-1 having a first wavelength is referred to as a first laser diode 121, and the laser diode 120 that emits a second irradiation light BM2-1 having a second wavelength will be referred to as a second laser diode 122. The reflected light of the first irradiation light BM1-1 reflected by the target object T is referred to as first reflected light BM1-2, and the reflected light of the second irradiation light BM2-1 reflected by the target object T is referred as second reflected light BM2-2.

The imaging device 10 may include the plurality of laser diodes 120 that emit irradiation light having the same wavelength. That is, the imaging device 10 may include a plurality of first laser diodes 121 and a plurality of second laser diodes 122. The plurality of laser diodes 120 may be included on a circumference centered on the optical axis on which the lens 110 receives reflected light. Further, the imaging device 10 may include a number of sensors according to a type of wavelength of the irradiation light emitted by the plurality of laser diodes 120.

Further, the imaging device 10 may include an image sensor (not shown). When the imaging device 10 includes the image sensor, the imaging device 10 images the target object T at an angle of view a. Specifically, a plurality of pixels included in the image sensor receive visible light focused by the lens 110, and form image information based on the received information.

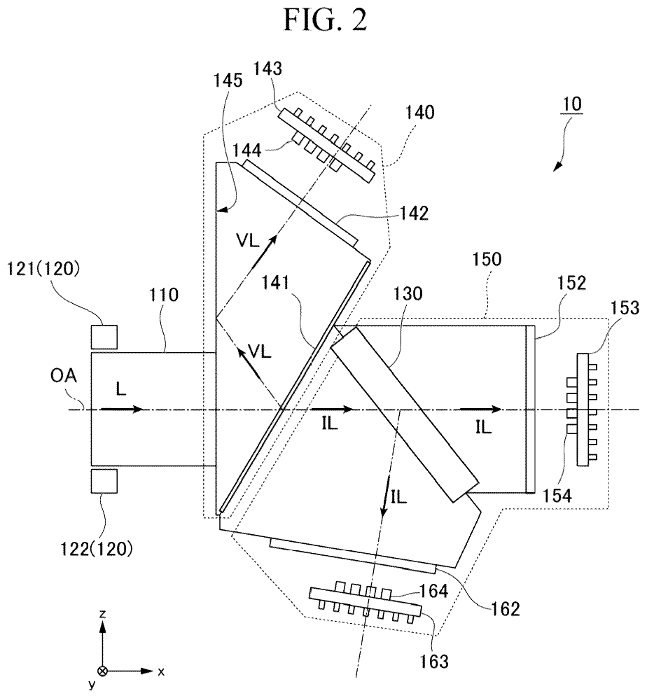

FIG. 2 is a schematic diagram showing an example of a cross section of the imaging device according to Embodiment 1. An example of a configuration of the imaging device 10 will be described with reference to FIG. 2.

The imaging device 10 includes the lens 110, the laser diode 120, an image capturing unit 140, and a distance measurement unit 150. The image capturing unit 140 captures an image using visible light, and the distance measurement unit 150 performs distance measurement using infrared light. That is, the imaging device 10 may be a time of flight (ToF) camera that measures the three-dimensional shape of an object.

It is known that sunlight is absorbed and attenuated by the atmosphere of the Earth before reaching the surface of the Earth. In particular, absorption by water vapor molecules present in the atmosphere has a large influence on wavelength characteristics. Specifically, at wavelengths such as 850 [nm (nanometers)], 940 [nm], and 1110 [nm], wavelength attenuation due to absorption by water vapor molecules is significant. Further, at 730 [nm], wavelength attenuation due to absorption by oxygen molecules is significant.

Three factors including sunlight attenuation, lens transmittance, and image sensor spectral sensitivity are particularly important for a distance measurement technology using infrared rays. In the present embodiment, an example of a case where laser diodes that emit near-infrared light beams which are laser diode light beams in 850 [nm] and 940 [nm] wavelength bands which are balanced are used will be described. The laser diode light in the 850 [nm] wavelength band is used for indoor distance measurement, and the laser diode light in the 940 [nm] wavelength band is used for outdoor distance measurement.

The imaging device 10 includes the first laser diode 121 as a light source that emits the laser diode light in the 940 [nm] wavelength band. The imaging device 10 also includes the second laser diode 122 as a light source that emits the laser diode light in the 850 [nm] wavelength band.

940 [nm] is also described as the first wavelength. Further, the irradiation light having a wavelength of 940 [nm] is also referred to as the first irradiation light. In other words, the first laser diode 121 is a first light source that emits the first irradiation light that is light having the first wavelength.

850 [nm] is also described as the second wavelength. Further, the irradiation light having a wavelength of 850 [nm] is also referred to as the second irradiation light. In other words, the second laser diode 122 is a second light source that emits the second irradiation light that is light having the second wavelength. The first wavelength and the second wavelength are different wavelengths. Further, it is preferable for the attenuation of the sunlight in a first wavelength band to be more significant than in a second wavelength band.

The image capturing unit 140 captures an image using visible light from the light incident on the lens 110. The image capturing unit 140 includes a visible light reflection dichroic film 141, an infrared cut filter 142, a sensor 143, and a reflection surface 145.

The visible light reflection dichroic film 141 reflects visible light and transmits light with wavelengths in a near-infrared region or above (that is, infrared light).

For light L incident on the lens 110, visible light VL is reflected and infrared light IL is transmitted by the visible light reflection dichroic film 141. An optical axis of the lens 110 will be referred to as an optical axis OA. The visible light VL reflected by the visible light reflection dichroic film 141 is reflected on the reflection surface 145 and is incident on the sensor 143 via the infrared cut filter 142.

The visible light VL and the infrared light (that is, the first reflected light and the second reflected light) pass through substantially the same optical axis between the lens 110 and the visible light reflection dichroic film 141. The substantially same range may be, for example, a range where optical paths are formed by a common lens.

The infrared cut filter 142 blocks the infrared light in the visible light VL.

The sensor 143 detects the visible light VL that is incident through the infrared cut filter 142. The sensor 143 includes a plurality of pixels 144. Specifically, the sensor 143 may be an image sensor in which RGB color pixels are disposed in a Bayer array.

The sensor 143 is also referred to as a third detection unit, and the visible light reflection dichroic film 141 is also referred to as a visible light reflection film. The third detection unit detects the visible light. The visible light reflection film reflects the visible light VL incident on the lens 110 to guide the visible light VL to the sensor 143. Further, the visible light reflection film transmits the first reflected light and the second reflected light which are infrared light in the light L incident on the lens 110. The visible light reflection film transmits the infrared light in the light L incident on the lens 110 to guide the first reflected light to the sensor 153 and the second reflected light to the sensor 163.

Further, the visible light reflection film is provided on an optical path between the lens 110 and a half mirror 130.

The distance measurement unit 150 includes the half mirror 130, a band pass filter 152, a sensor 153, a band pass filter 162, and a sensor 163. The sensor 153 and the sensor 163 are also referred to as ToF sensors.

The infrared light transmitted through the visible light reflection dichroic film 141 is split into two optical paths for transmitted light and reflected light by the half mirror 130 in the distance measurement unit 150. The half mirror 130 may be, for example, a dielectric half mirror.

The half mirror 130 is provided on an optical path between the lens 110 and the sensor 153 and on an optical path between the lens 110 and the sensor 163. Further, the first reflected light and the second reflected light pass through substantially the same optical axis between the lens 110 and the half mirror 130. The substantially same range may be, for example, a range where optical paths are formed by a common lens.

The half mirror 130 may be an optical member that transmits part of the incident light and reflects the other part of the light. The half mirror 130 guides the first reflected light to the sensor 153 by transmitting part of the light emitted from the first laser diode 121 and reflected by the target object T. Further, the half mirror 130 guides the second reflected light to the sensor 163 by reflecting part of the light emitted from the second laser diode 122 and reflected by the target object T.

The light split into two optical paths for the transmitted light and the reflected light by the half mirror 130 is received by the ToF sensor disposed in each optical path. Specifically, the light transmitted through the half mirror 130 is received by the sensor 153, and the light reflected by the half mirror 130 is received by the sensor 163.

An optical band pass filter that transmits only light having a wavelength in a predetermined narrow band is disposed in front of each ToF sensor (that is, on an optical path between the half mirror 130 and each ToF sensor). Specifically, the band pass filter 152 is disposed in front of the sensor 153.

The band pass filter 152 transmits only a narrow band of 940 [nm]. Furthermore, the band pass filter 162 is disposed in front of the sensor 163. The band pass filter 162 transmits only a narrow band of 850 [nm].

The sensor 153 is also referred to as a first detection unit. The first detection unit detects the first reflected light that is reflected light of the first irradiation light with which the target object T is irradiated by the first laser diode 121. Further, the sensor 163 is also referred to as a second detection unit. The second detection unit detects second reflected light that is reflected light of the second irradiation light with which the target object T is irradiated by the second laser diode 122.

A spectral ratio of the transmitted light and the reflected light in the half mirror 130 is changed depending on usage conditions so that optimal signal detection can be performed in both an 850 [nm] band and a 940 [nm] band.

### Modification Example 1 of Embodiment 1

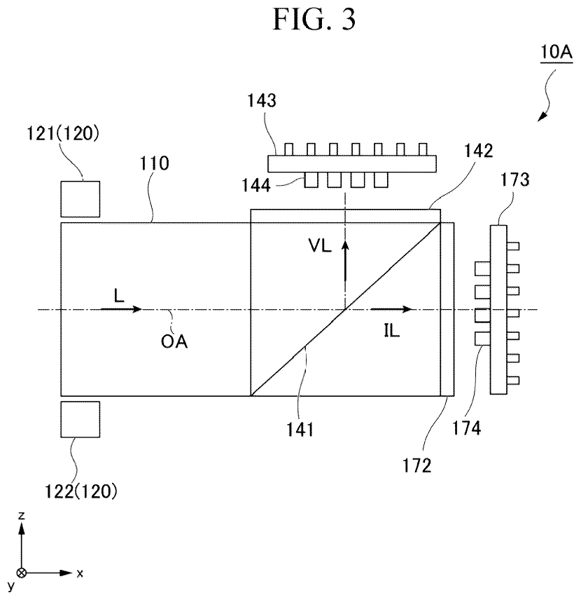

FIG. 3 is a schematic diagram showing an example of a cross section of an imaging device according to Modification Example 1 of Embodiment 1. An example of a configuration of an imaging device 10A, which is a first modification of the imaging device 10, will be described with reference to FIG. 3. The imaging device 10A differs from the imaging device 10 in that the imaging device 10A does not include the half mirror 130 and further includes a switching band pass filter 172. Since the imaging device 10A includes the switching band pass filter 172, the imaging device 10A does not need to include two ToF sensors, and detects both the first reflected light and the second reflected light using one of the ToF sensors. In the description of the imaging device 10A, the same components as those in the imaging device 10 may be denoted by the same reference signs, and a description thereof may be omitted.

The visible light VL and the infrared light IL are incident on the lens 110. Here, the visible light VL and the infrared light IL are incident on the lens 110 through a common optical axis OA. The light L incident on the lens 110 is incident on the visible light reflection dichroic film 141. The reflection dichroic film 141 reflects the incident visible light VL and guides the incident visible light VL to the sensor 143. Further, the reflection dichroic film 141 transmits the incident infrared light IL and guides the incident infrared light IL to the switching band pass filter 172.

The switching band pass filter 172 has both a function of the band pass filter 152 and a function of the band pass filter 162. The switching band pass filter 172 switches between the two functions in time division. That is, the switching band pass filter 172 exclusively has a period in which only the 940 [nm] narrow band is transmitted and a period in which only the 850 [nm] narrow band is transmitted.

Specifically, the switching band pass filter 172 may have a rotating structure for rotating the filter. In this case, the filter may have a disc shape, and include one semicircular part having a filter that passes only the narrow band of 940 [nm], and another semicircular part having a filter that passes only the narrow band of 850 [nm]. The switching band pass filter 172 may rotate the disc and align the optical axis with any one of the filters to exclusively switch between a period in which only the 940 [nm] narrow band is transmitted and a period in which only the 850 [nm] narrow band is transmitted.

Further, the switching band pass filter 172 may have a sliding structure for sliding the filter. In this case, the filter may have a rectangular shape, and include a filter that passes only the narrow band of 940 [nm] on one side, and a filter that passes only the narrow band of 850 [nm] on the other side. The switching band pass filter 172 may slide the rectangular filter and align the optical axis with one of the filters, to exclusively switch between a period in which only the 940 [nm] narrow band is transmitted and a period in which only the 850 [nm] narrow band is transmitted.

### Modification Example 2 of Embodiment 1

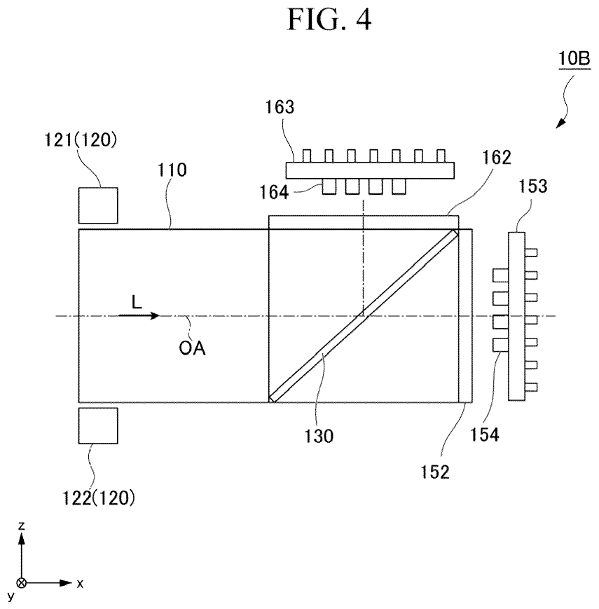

FIG. 4 is a schematic diagram showing an example of a cross section of an imaging device according to Modification Example 2 of Embodiment 1. An example of a configuration of an imaging device 10B, which is a Modification Example 2 of the imaging device 10, will be described with reference to FIG. 4. The imaging device 10B differs from the imaging device 10 in that the imaging device 10B does not include the image capturing unit 140. That is, the imaging device 10B is a distance measuring sensor that does not have an image sensor. In the description of the imaging device 10B, the same components as those of the imaging device 10 may be denoted by the same reference signs, and a description thereof may be omitted.

The light L incident on the lens 110 is split into two optical paths for transmitted light and reflected light by the half mirror 130. The transmitted light is incident on the sensor 153 and the reflected light is incident on the sensor 163. The band pass filter 152 which transmits only the narrow band of 940 [nm] is included on an optical path between the half mirror 130 and the sensor 153. Further, the band pass filter 162 that transmits only the narrow band of 850 [nm] is included on an optical path between the half mirror 130 and the sensor 163.

### Modification Example 3 of Embodiment 1

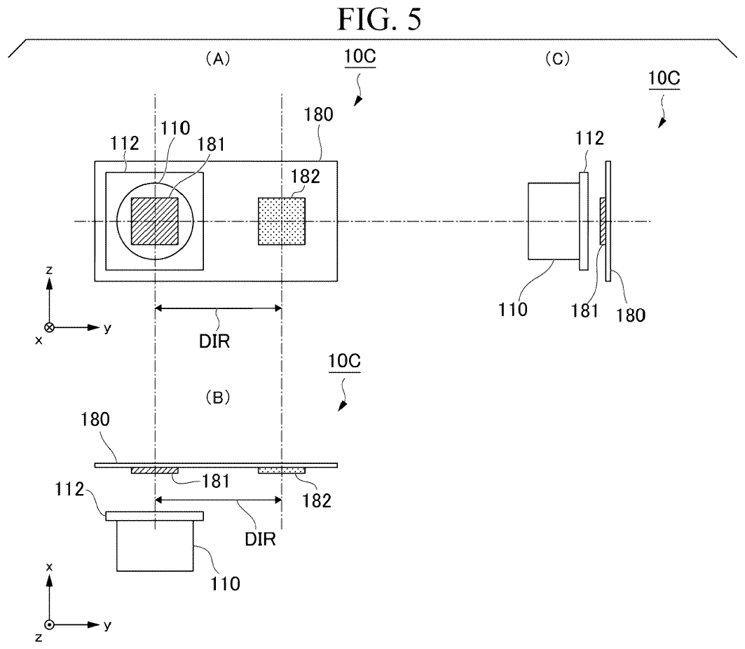

FIG. 5 is a diagram illustrating an imaging device according to Modification Example 3 of Embodiment 1. An example of a configuration of an imaging device 10C, which is Modification Example 3 of the imaging device 10, will be described with reference to FIG. 5. The imaging device 10C has an image sensor and one ToF sensor. The imaging device 10C differs from the imaging device 10 in that the imaging device 10C does not include the visible light reflection dichroic film 141 and the half mirror 130. In the description of the imaging device 10C, the same components as the imaging device 10 may be denoted by the same reference signs, and a description thereof may be omitted.

FIG. 5(A) is a front view of the imaging device 10C. The imaging device 10C includes a board 180. The board 180 includes an infrared cut filter unit 181 and a band pass filter unit 182. The infrared cut filter unit 181 blocks the infrared light in the light incident on the lens 110 and transmits the visible light. The band pass filter unit 182 transmits light having a predetermined wavelength in the light incident on the lens 110, and blocks light other than the light having a predetermined wavelength.

The imaging device 10C has a slide mechanism (not shown), and changes relative positions of the lens 110 and the housing 112 and the board 180 in a y-axis direction (slide direction DIR). The imaging device 10C causes the light incident on the lens 110 to be incident on any one of the infrared cut filter unit 181 or the band pass filter unit 182 by including the slide mechanism. The light incident on the infrared cut filter unit 181 is incident on the RGB sensor, and the light incident on the band pass filter unit 182 is incident on the ToF sensor.

FIG. 5(B) is a plan view of the imaging device 10C. In an example shown in FIG. 5(B), the slide mechanism is located at a position where the light incident on the lens 110 is made incident on the infrared cut filter unit 181. As shown in FIG. 5(B), when the relative positions of the lens 110 and the housing 112 and the board 180 are changed along the slide direction DIR, an optical axis of the light incident on the lens 110 is changed from the infrared cut filter unit 181 to the band pass filter unit 182.

FIG. 5(C) is a side view of the imaging device 10C. In FIG. 5(C), a cross section on an xz plane that crosses the infrared cut filter unit 181 is shown. As shown in FIG. 5(C), the optical axes of the lens 110 and the housing 112, and the infrared cut filter unit 181 included on the board 180 match. Further, a cross section crossing the band pass filter unit 182 is not shown, but the optical axes of the lens 110 and the housing 112, and the band pass filter unit 182 included on the board 180 similarly match.

### Modification Example 4 of Embodiment 1

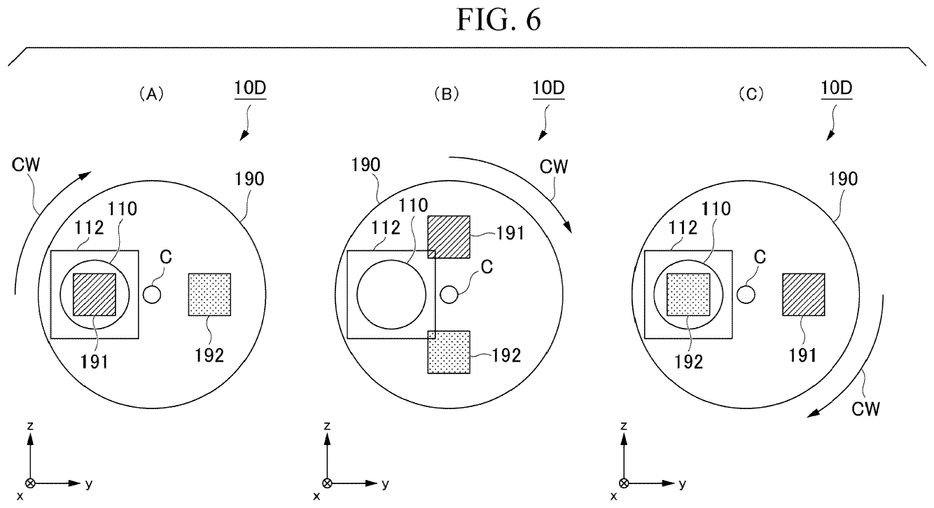

FIG. 6 is a diagram illustrating an imaging device according to Modification Example 4 of Embodiment 1. An example of a configuration of an imaging device 10D, which is Modification Example 4 of the imaging device 10, will be described with reference to FIG. 6. The imaging device 10D includes an image sensor and one ToF sensor. The imaging device 10D differs from the imaging device 10 in that the imaging device 10D does not include the visible light reflection dichroic film 141 and the half mirror 130. Further, the imaging device 10D is the same as the imaging device 10C in that the imaging device 10D does not include the visible light reflection dichroic film 141 and the half mirror 130. On the other hand, the imaging device 10D differs from the imaging device 10C in that the imaging device 10D has a rotation mechanism instead of the slide mechanism included in the imaging device 10C. In the description of the imaging device 10D, the same components as the imaging device 10C may be denoted by the same reference signs and a description thereof may be omitted.

FIGS. 6(A) to 6(C) are all front views of the imaging device 10D. The imaging device 10D includes a board 190. The board 190 includes an infrared cut filter unit 191 and a band pass filter unit 192. The infrared cut filter unit 191 blocks the infrared light in the light incident on the lens 110 and transmits the visible light. The band pass filter unit 192 transmits light having a predetermined wavelength in the light incident on the lens 110, and blocks light other than the light having a predetermined wavelength.

The imaging device 10D includes a rotation mechanism (not shown) and rotates the board 190 around a rotation center C. The imaging device 10D rotates the board 190 clockwise CW or counterclockwise CCW (not shown) to change the optical axis of the light incident on the lens 110 to the infrared cut filter unit 191 or the band pass filter unit 192.

FIG. 6(A) shows an example in which is located at a position where the light incident on the lens 110 is incident on the infrared cut filter unit 191, and FIG. 6(B) shows an example in which the board 190 has been rotated 90 degrees clockwise CW by the imaging device 10D. At the position shown in FIG. 6(A), the light incident on the lens 110 is not incident on any one of the infrared cut filter unit 191 and the band pass filter unit 192. FIG. 6(C) is an example in which the board 190 is rotated further clockwise CW by 90 degrees from the position shown in FIG. 6(B) by the imaging device 10D. At the position shown in the figure, the light incident on the lens 110 is incident on the band pass filter unit 192.

When one half of the board 190 is formed as the infrared cut filter unit 191 and the other half is formed as the band pass filter unit 192, it is also possible to prevent a state in which the light incident on the lens 110 is incident on neither the filter unit 191 nor the band pass filter unit 192, as shown in FIG. 6(B).

### Summary of Embodiment 1

According to the embodiment described above, the imaging device 10 includes the first laser diode (first light source) 121 to irradiate the target object T with the first irradiation light which is light having the first wavelength, includes the second laser diode (second light source) 122 to irradiate the target object T with the second irradiation light having the second wavelength, includes the sensor (first detection unit) 153 to detect the first reflected light that is reflected light of the first irradiation light with which the target object T is irradiated, and includes the sensor (second detection unit) 163 to detect the second reflected light that is reflected light of the second irradiation light with which the target object T is irradiated. Further, the imaging device 10 includes the half mirror (optical member) 130 to split the light incident on the lens 110 into the sensor 153 and the sensor 163. Furthermore, the imaging device 10 includes the band pass filter 152 on the optical path between the half mirror 130 and the sensor 153 to allow only the narrow band of 940 [nm] to be transmitted through the sensor 153 and includes the band pass filter 162 on the optical path between the half mirror 130 and the sensor 163 to allow only the narrow band of 850 [nm] to be transmitted through the sensor 163.

Therefore, according to the present embodiment, with the imaging device 10, it is possible to supplement data obtained under each other's weak conditions since distance measurement data of an 850 [nm] ToF camera with characteristics suitable for indoor use and a 940 [nm] ToF camera with characteristics suitable for outdoor use are simultaneously obtained. Therefore, the imaging device 10 can accurately measure the distance to the target object even in a plurality of different environments.

Further, according to the embodiment described above, the half mirror 130 included in the imaging device 10 is provided on an optical path between the lens 110 and the sensors 153 and 163, and the first reflected light and the second reflected light pass through substantially the same optical axis between the lens 110 and the half mirror 130. Therefore, according to the present embodiment, it is not necessary to include respective optical paths for the first reflected light and the second reflected light and to downsize the imaging device 10.

Further, according to the embodiment described above, the imaging device 10 includes the sensor (the third detection unit) 143 to detect the visible light, and includes the visible light reflection dichroic film (the visible light reflection film) 141 to guide the infrared light to the sensor 153 and sensor 163 and guide the visible light to the sensor 143. Therefore, according to the imaging device 10, it is possible to obtain an RGB image and distance measurement information. Therefore, the imaging device 10 can obtain a highly accurate 3D image by combining the acquired RGB image with the distance measurement information.

Furthermore, according to the embodiment described above, the visible light reflection dichroic film 141 included in the imaging device 10 is provided on the optical path between the lens 110 and the half mirror 130. That is, according to the imaging device 10, the incident light is first divided into visible light and infrared light, and then the infrared light is further split into two infrared light beams. Therefore, according to the present embodiment, it is possible to easily obtain the RGB image and the distance measurement information.

Further, according to the embodiment described above, in the imaging device 10, the visible light passes through substantially the same optical axis as the first reflected light and the second reflected light between the lens 110 and the visible light reflection dichroic film 141. Therefore, according to the imaging device 10, it is possible to obtain the highly accurate 3D image in real time by combining the RGB image obtained on the same optical axis with the distance measurement information.

### [Effects Due to Same Optical Axis]

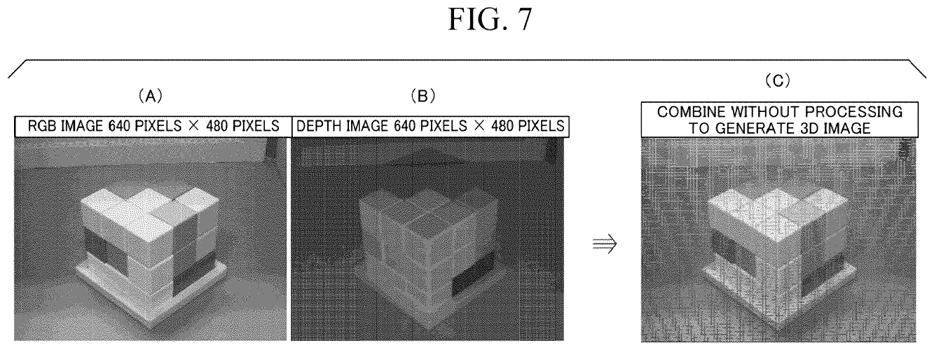

Next, effects when the optical axes are made the same will be described in detail with reference to FIGS. 7 to 11.

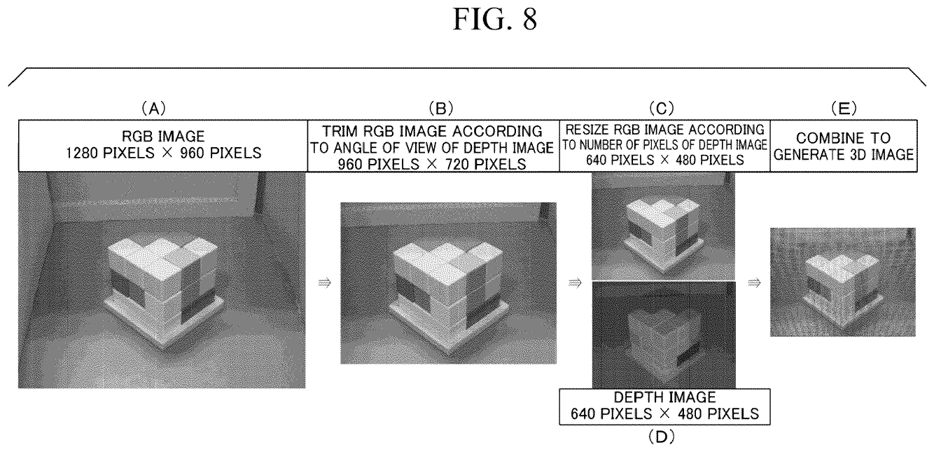

First, the effect when the number of pixels and the angle of view are the same or known will be described with reference to FIGS. 7 and 8.

FIG. 7 is a diagram illustrating effects when the RGB sensor and the ToF sensor have the same number of pixels and the same angle of view in the imaging device according to Embodiment 1. In the example shown in FIG. 7, the imaging device 10 includes the RGB sensor and the ToF sensor that have the same number of pixels and the same angle of view (image size). Specifically, both the RGB sensor and the ToF sensor are 640 pixels×480 pixels. Further, the RGB sensor and the ToF sensor have the same optical axis.

FIG. 7(A) is an example of the RGB data acquired by the RGB sensor. Further, FIG. 7(B) is an example of depth data acquired by the ToF sensor. The depth data includes, for example, distance information from the imaging device 10 to the target object T. Specifically, the depth data may include distance information corresponding to each of a plurality of pixels included in two-dimensional image information. FIG. 7(C) is an example of 3D point cloud data generated based on the acquired RGB data and depth data.

In the present embodiment, since the numbers of pixels and angles of view of the RGB sensor and the ToF sensor are the same, the imaging device 10 does not need to perform processing for matching the numbers of pixels and angles of view of the acquired RGB data and depth data. Further, since the RGB sensor and the ToF sensor have the same optical axis, there is no parallax or FoV difference between the RGB data and the depth data. Accordingly, the imaging device 10 does not require parallax correction for angle-of-view matching or surrounding angle-of-view restriction processing based on the FoV difference. Therefore, according to the present embodiment, the imaging device 10 can generate 3D point cloud data without correcting the RGB data and the depth data (that is, without any processing).

FIG. 8 is a diagram illustrating effects when the numbers of pixels and field angle matching parameters of the RGB sensor and the ToF sensor are known in the imaging device according to Embodiment 1.

In the example shown in FIG. 8, the numbers of pixels and the angles of view of the RGB sensor and the ToF sensor are different. Specifically, the number of pixels of the RGB sensor is 1280 pixels×960 pixels. Further, the number of pixels of the ToF sensor is 640 pixels×480 pixels. Further, the RGB sensor and the ToF sensor have the same optical axis.

FIG. 8(A) is an example of the RGB data acquired by the RGB sensor. FIG. 8(B) is an example of RGB data trimmed according to an angle of view at which the depth data has been acquired. FIG. 8(C) is an example of RGB data resized according to the number of pixels of the depth data. FIG. 8(D) is an example of the depth data acquired by the ToF sensor. FIG. 8(E) is an example of 3D point cloud data generated based on the processed RGB data and the acquired depth data.

As shown in FIGS. 8(A) to 8(C), when the numbers of pixels and the angles of view of the RGB sensor and the ToF sensor are different, data with a larger number of pixels is matched with data with a smaller number of pixels. Specifically, in the present embodiment, since the number of pixels of the RGB sensor is larger than the number of pixels of the ToF sensor, the RGB data is first trimmed and then resized.

That is, even when the numbers of pixels and angles of view of the RGB sensor and the ToF sensor are different, the imaging device 10 can easily perform matching in the number of pixels and matching in the angle of view of the acquired RGB data and depth data as long as a ratio parameter for trimming sensor side data with a wide angle of view to a narrow angle of view of the other side or a resizing ratio parameter for matching the numbers of pixels is known in advance. Furthermore, since the RGB sensor and the ToF sensor have the same optical axis, there is no parallax or FoV difference. Therefore, the imaging device 10 does not require the parallax correction for angle-of-view matching or the surrounding angle-of-view restriction processing based on the FoV difference. Therefore, according to the present embodiment, the imaging device 10 can easily generate the 3D point cloud data from the RGB data and the depth data.

Since the RGB sensor and the ToF sensor have the same optical axis, the imaging device 10 can apply the same correction data to the RGB data and the depth data even when processing such as distortion correction, surrounding light decrease correction, and chromatic aberration correction due to lens characteristics of the lens 110 is required. That is, since it is not necessary to apply different correction data to the RGB data and the depth data, the imaging device 10 can easily correct the data.

However, there is a correlation between characteristics of the visible light and the infrared light but, for example, when there is a difference, it may be necessary to perform correction according to the correlation.

Since the RGB sensor and the ToF sensor have the same optical axis, the imaging device 10 can integrate image frequency information obtained by the RGB sensor with distance information of a subject obtained by the ToF sensor to perform more accurate focusing or edge detection.

According to the present embodiment, even when sufficient information cannot be obtained from the RGB sensor in a dark time such as at night or in a dark area that is a shadow, the imaging device 10 can generate 3D data based on distance information obtained from the ToF sensor.

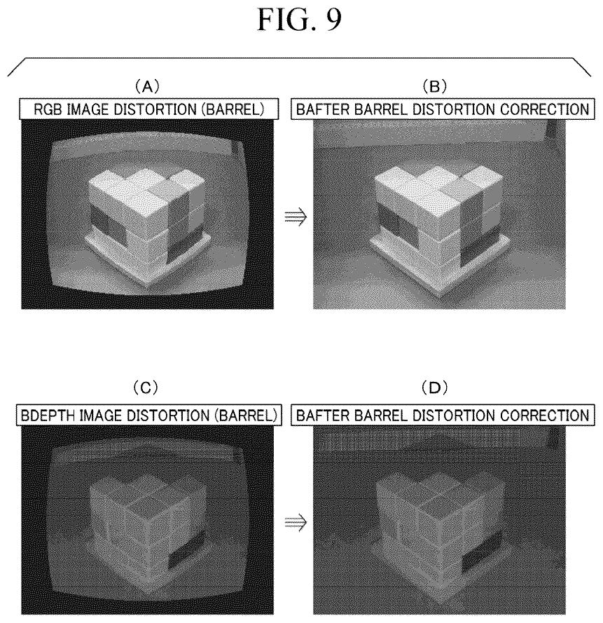

Next, an example of a case where various corrections due to lens characteristics is applied to the ToF camera will be described with reference to FIGS. 9 to 11. According to the present embodiment, since the RGB sensor and the ToF sensor have the same optical axis, various corrections due to the lens characteristics can be applied to the ToF camera. Furthermore, it is possible to improve the accuracy of focusing through edge detection of an RGB camera of the related art by using the distance information obtained by the ToF sensor together.

In the example shown in FIGS. 9 to 11, an example of a case where the imaging device 10 includes an RGB sensor and a ToF sensor having the same number of pixels and the same angle of view (image size), and the RGB sensor and the ToF sensor have the optical axis will be described.

FIG. 9 is a diagram illustrating sharing of distortion correction values in the imaging device according to Embodiment 1. The sharing of the distortion correction values will be described with reference to FIG. 9.

FIG. 9(A) is an example of the RGB data acquired by the RGB sensor. The RGB data shown in FIG. 9(A) is barrel distorted. FIG. 9(B) is an example of a case where the RGB data acquired by the RGB sensor is subjected to barrel distortion correction. FIG. 9(C) is an example of the ToF data acquired by the ToF sensor. The ToF data shown in FIG. 9(C) suffers from barrel distortion like the RGB data. FIG. 9(D) is an example of a case where the ToF data acquired by the ToF sensor is subjected to barrel distortion correction.

The ToF data is an example of the depth data acquired by the ToF sensor.

Since the RGB sensor and the ToF sensor share the same optical axis, the RGB data and the ToF data similarly suffer from the barrel distortion, as shown in the example shown in FIG. 9, and it is possible to directly apply distortion correction data calculated from distortion information of the lens obtained by the RGB sensor to distortion correction for ToF data. That is, according to the present embodiment, the RGB data and the ToF data can share correction values. Therefore, according to the present embodiment, it is possible to easily perform the correction.

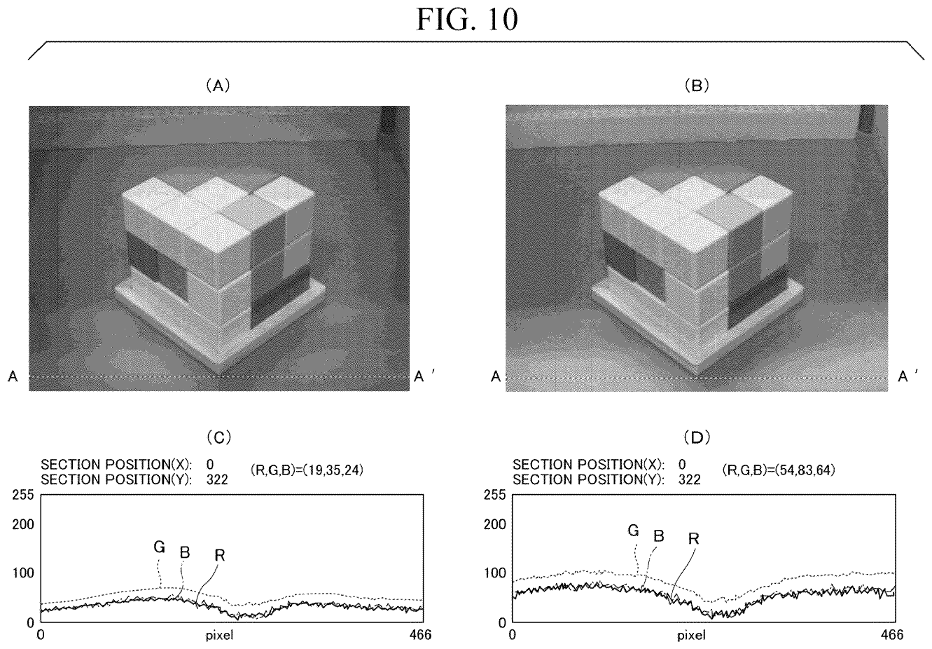

FIG. 10 is a diagram illustrating sharing of surrounding light decrease correction data in the imaging device according to Embodiment 1. The sharing of the surrounding light decrease correction data will be described with reference to FIG. 10.

FIG. 10(A) is an example of the RGB data acquired by the RGB sensor. In the RGB data shown in FIG. 10(A), the amount of surrounding light is low (not sufficient). FIG. 10(B) is an example of a case where the RGB data acquired by the RGB sensor is subjected to surrounding light decrease correction. In the RGB data shown in FIG. 10(B), surrounding light amount has been corrected. FIG. 10(C) shows the light amount of each RGB color in an A-A′ cross section of the data shown in FIG. 10(A) on a vertical axis, and coordinates (pixels) in a horizontal direction of the image on a horizontal axis. FIG. 10(D) shows a light amount of each RGB color in an A-A′ cross section of the data shown in FIG. 10(B) on a vertical axis, and coordinates (pixels) in a horizontal direction of the image on a horizontal axis.

As in the example shown in FIG. 10, according to the present embodiment, since the RGB sensor and the ToF sensor have the same optical axis, the imaging device 10 can also use surrounding light decrease correction data calculated from the surrounding light decrease information of the lens obtained by the RGB sensor as it is, for the surrounding light decrease correction of the ToF data.

However, when there is a correlation between surrounding light decrease characteristics of the visible light and the infrared light but, for example, when there is a difference, it may be necessary to perform correction according to the correlation.

Here, in a twin-lens camera as in the related art, since the RGB data and the ToF data have different surrounding light decrease correction data, an amount of correction has to be changed depending on characteristics of each lens. According to the present embodiment, since the same or corresponding correction data can be applied to the RGB data and the ToF data, it is possible to easily correct the RGB data and the ToF data.

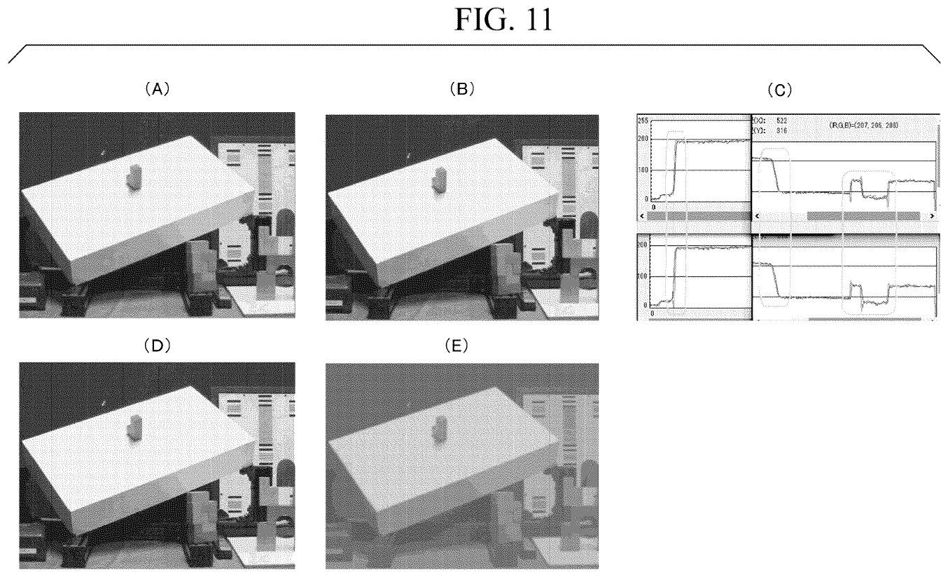

FIG. 11 is a diagram illustrating sharing of chromatic aberration correction data in the imaging device according to Embodiment 1. The sharing of the chromatic aberration correction data will be described with reference to the same figure.

FIG. 11(A) is an example of the RGB data in which chromatic aberration with a left edge being red and a right edge being cyan occurs. FIG. 11(B) is an example of the RGB data in which chromatic aberration with a left edge being cyan and a right edge being red occurs. An upper row of FIG. 11(C) is an example of left and right edge waveforms of FIG. 11(A), and a low row of FIG. 11(C) is an example of the left and right edge waveforms of FIG. 11(B). FIG. 11(D) is an example of RGB data after lateral chromatic aberration correction processing is performed. FIG. 11(E) is an example of ToF data after magnification difference correction processing is performed.

The imaging device 10 calculates lateral chromatic aberration correction data based on lateral chromatic aberration information of the lens 110 obtained from the RGB data. The imaging device 10 also applies the obtained lateral chromatic aberration correction data to the magnification difference correction of an image of the ToF data. In particular, the imaging device 10 uses lateral chromatic aberration correction data of Rch close to a near-infrared region used in the ToF camera as it is for the magnification difference correction of the ToF data. Further, the imaging device 10 may estimate a correlated magnification difference correction amount in the near-infrared region from Rch chromatic aberration correction data and apply the magnification difference correction amount.

Furthermore, the imaging device 10 detects an edge of the subject that has a distance difference from a background from the distance information obtained from the ToF data. The imaging device 10 detects the edge of the subject that have a difference in luminance or a difference in frequency based on a signal obtained from the RGB data. By using these together, the imaging device 10 can further improve the accuracy of edge detection and use this for focusing of the camera.

Further, the imaging device 10 uses the Rch lateral chromatic aberration correction data for the ToF data to correct a magnification difference between images of the RGB data and the ToF data. The imaging device 10 corrects the magnification difference between the images of the RGB data and the ToF data to accurately overlap the images at the time of generating 3D data and curb occurrence of distance deviation of an edge portion.

### Embodiment 2

Next, Embodiment 2 will be described. An imaging device 10 according to the present embodiment includes a first laser diode (first light source) 121 to emit first irradiation light having a first wavelength, and includes a sensor (first detection unit) 153 detect first reflected light which is reflected light of the first irradiation light reflected by the target object. Further, the imaging device 10 includes a second laser diode (second light source) 122 to emit second irradiation light that is light having a second wavelength different from the first wavelength, and includes a sensor (second detection unit) 163 to detect second reflected light which is reflected light of the second irradiation light reflected by the target object.

Here, since the first irradiation light and the first reflected light, and the second irradiation light and the second reflected light have different wavelengths, the first irradiation light and the first reflected light may interfere with the second irradiation light and the second reflected light. In Embodiment 2, interference between light beams with different wavelengths is attempted to be curbed.

In the description of Embodiment 2, an example of a case where the imaging device 10 described with reference to FIG. 2 is used will be described. However, a control method according to Embodiment 2 is not limited to the example of the case where the control method is applied to the imaging device 10, and the control method can be similarly applied to the imaging devices 10A to 10D.

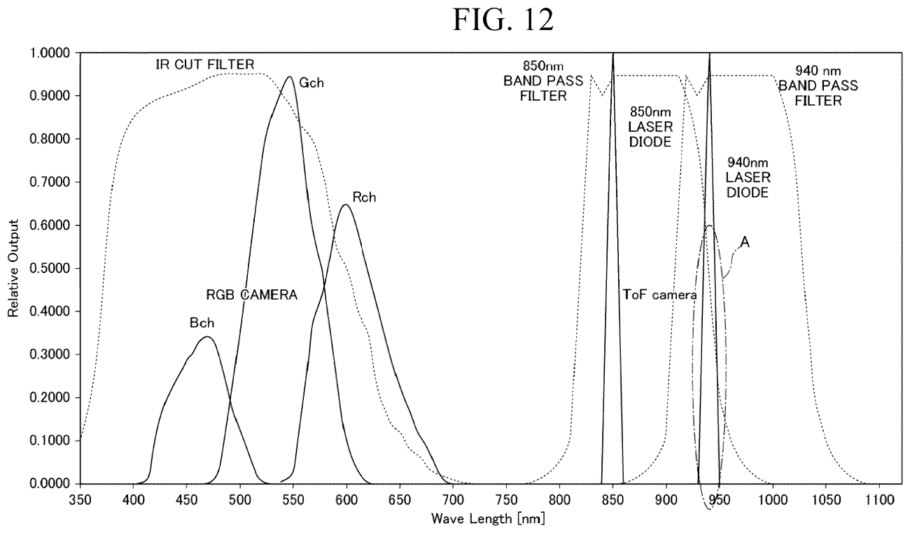

FIG. 12 is a diagram illustrating an interference between near-infrared light beams with two different wavelengths according to Embodiment 2. The interference between the near-infrared light beams with two different wavelengths will be described with reference to FIG. 12.

In FIG. 12, a horizontal axis indicates a wavelength [nm] and a vertical axis indicates a relative output for output of visible light (Rch, Gch, and Bch) received by the RGB camera and infrared light (850 nm and 940 nm) received by the ToF camera. Further, in FIG. 12, wavelengths that can be cut off by an IR cut filter (the infrared cut filter 142), a 940 nm band pass filter (the band pass filter 152), and an 850 nm band pass filter (the band pass filter 162) are similarly shown.

850 [nm] and 940 [nm] band pass filters used in a general ToF camera often have a bandwidth of about 150 [nm]. It is possible to remove an influence of a visible light region by applying the 940 nm band pass filter and the 850 nm band pass filter shown in FIG. 12.

However, when near-infrared light beams with 850 [nm] and 940 [nm] are emitted simultaneously, interference of the infrared light beams having different wavelengths cannot be completely eliminated. Specifically, in a range A, near-infrared light beams with 850 [nm] and 940 [nm] interfere with each other.

In order to prevent such interference, it is effective to use a band pass filter for a narrowband capable of sharp cut-off within 100 [nm], rather than a general-purpose band pass filter used for a ToF camera. However, the band pass filter for a narrowband capable of sharp cut-off within 100 [nm] is expensive. Therefore, in Embodiment 2, the imaging device 10 curbs interference between wavelengths by controlling a light emission timing of the laser diode and an exposure timing of the sensor.

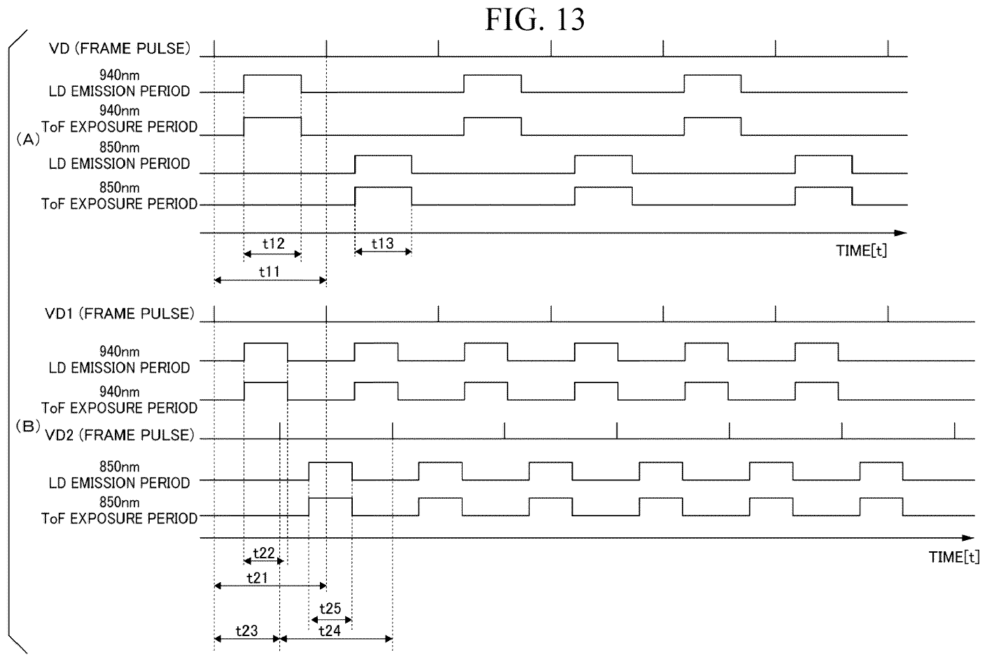

FIG. 13 is a timing chart showing an example of an operation period of irradiation and exposure of the laser light according to Embodiment 2. An example of a period in which a light emission operation of the laser diode is performed and a period in which an exposure operation of the sensor is performed will be described with reference to FIG. 13. In FIG. 13, a period in which a light emission operation of the first laser diode 121 is performed is shown as a “940 nm LD light emission period”. An “exposure period of the 940 nm ToF” indicates a period in which an exposure operation of the sensor 153 is performed. A period in which a light emission operation of the second laser diode 122 is performed is indicated as a “850 nm LD light emitting period.” A “850 nm ToF exposure period” indicates a period in which an exposure operation of the sensor 163 is performed.

A horizontal axis indicates time, and a vertical axis indicates whether the light emission or the exposure is an on period or an off period. A high level indicates on, and a low level indicates off. Similarly, a frame pulse timing is shown with the horizontal axis as time. The on or off period shown in FIG. 13 indicates the period in which the light emission operation of the laser diode is performed or the period in which an exposure operation of the sensor is performed, and an actual control signal may repeat a plurality of switching operations during the period. Specifically, in an actual on-period, the LD light emission period and the ToF exposure period each consist of a plurality of fine control pulses, and the LD light emission period and the ToF exposure period may not necessarily be in the same phase.

FIG. 13(A) is a timing chart illustrating an example of a first interference prevention measure. First, details of the first interference prevention measure will be described. In the first interference prevention measure, light emission and exposure of a 940 [nm] ToF sensor and light emission and exposure of an 850 [nm] ToF sensor are controlled based on a common frame pulse timing VD. The frame pulse timing VD has a cycle t11.

A period t12 that is period in which the first laser diode (first light source) 121 emits the first irradiation light and the sensor (first detection unit) 153 detects the first reflected light is referred to as a first period. A period t13 that is a period in which the second laser diode (second light source) 122 emits the second irradiation light and the sensor (second detection unit) 163 detects the second reflected light is referred to as a second period.

Processing performed in the first period and processing performed in the second period are performed in different frames. That is, the first period and the second period do not overlap.

Specifically, 850 [nm] laser diode emission and 850 [nm] ToF sensor exposure are performed in even-numbered frames, and 940 [nm] laser diode emission and 940 [nm] ToF sensor exposure are performed in odd-numbered frames, so that the operation timings of the laser diode light emission and the ToF sensor exposure are alternately controlled. In other words, the first period and the second period occur alternately at a predetermined period. Specifically, the first period is a period within an odd-numbered period in a predetermined cycle t11. Further, the second period is a period within an even-numbered period in the predetermined cycle t11.

The first period and the second period may be interchanged. Specifically, the 850 [nm] laser diode emission and the 850 [nm] ToF sensor exposure may be performed in odd-numbered frames, and the 940 [nm] laser diode emission and the 940 [nm] ToF sensor exposure may be performed in even-numbered frames.

As described above, in the first interference prevention measure, the operation timings of the laser diode light emission and the ToF sensor exposure are alternately controlled so that the interference of the near-infrared light is prevented. According to the first interference prevention measure, there is an advantage that laser diode light emission timing control between two wavelengths and exposure timing control of the ToF sensor can be managed by a common synchronization system. On the other hand, according to the first interference prevention measure, there is a problem that the distance measurement frame rate is halved. A second interference prevention measure solves the problem caused by the first interference prevention measure.

FIG. 13(B) is a timing chart illustrating an example of the second interference prevention measure. Next, details of the second interference prevention measure will be described. In the second interference prevention measure, control is performed based on a frame pulse timing VD1 for the 940 [nm] ToF sensor and a frame pulse timing VD2 for the 850 [nm] ToF sensor. The frame pulse timing VD1 has a cycle t21, and the frame pulse timing VD2 has a cycle t24. The cycle t21 will be described as a first cycle, and the cycle t24 will be described as a second cycle.

A period t22 that is a period in which the first laser diode (first light source) 121 emits the first irradiation light and the sensor (first detection unit) 153 detects the first reflected light is referred to as the first period. A period t25 that is a period in which the second laser diode (second light source) 122 emits the second irradiation light and the sensor (second detection unit) 163 detects the second reflected light is referred to as the second period.

In the second interference prevention measure, the first period is a period within the first cycle. Further, the second period is a period within the second period. In other words, the first period is a period based on the frame pulse timing VD1, and the second period is a period based on the frame pulse timing VD2. When processing performed in the first period and processing performed in the second period are performed overlappingly at the same timing, light beams with different wavelengths interfere. Therefore, the first period and the second period are controlled so that the first period and the second period do not overlap.

Furthermore, in the second interference prevention measure, the first cycle and the second cycle have different phases. Specifically, the frame pulse timing VD2 may be delayed by half a cycle from the frame pulse timing VD1. In other words, a phase difference between the first cycle and the second cycle may be half a cycle (180 degrees). Moreover, the cycle t21 which is the first cycle and the cycle t24 which is the second cycle may be the same cycle.

In the second interference prevention measure, the period in which the laser diode emits the irradiation light and the sensor detects the reflected light may be a period equal to or smaller than half the frame pulse period. Specifically, the first period within the first cycle may be smaller than or equal to half of the first cycle, and the second period within the second cycle may be smaller than or equal to half of the second cycle.

As described above, in the second interference prevention measure, the 850 [nm] laser diode emission and the 850 [nm] ToF sensor exposure are shifted by half a frame from the 940 [nm] laser diode emission and the 940 [nm] ToF sensor exposure, thereby preventing the near-infrared light beams with the respective wavelengths from interfering with each other.

According to the second interference prevention measure, the distance measurement frame rate is not halved unlike the first interference prevention measure, and the distance measurement frame rate can be maintained. However, according to the second interference prevention measure, there is a disadvantage that a synchronization circuit is complicated for both control and signal processing. Further, according to the second interference prevention measure, when a laser diode light emission period is elongated for long-distance distance measurement, an interval period becomes short and an interference between two wavelengths becomes unavoidable. When interference occurs due to the elongated light emission period, adjustment such as decreasing the frame rate is effective.

As another embodiment, when band pass filters for a narrowband that perform sharp attenuation at about respective center wavelengths of 850 [nm] and 940 [nm]±40 [nm] are used, it is possible to indefinitely eliminate the interference between near-infrared light beams with the respective wavelengths even without control ingenuity as described above.

### Summary of Embodiment 2

According to the embodiment described above, the imaging device 10 includes the first laser diode (first light source) 121 to irradiate the target object T with the first irradiation light which is light having the first wavelength, includes the second laser diode (second light source) 121 to irradiate the target object T with the second irradiation light having the second wavelength, includes the sensor (first detection unit) 153 to detect the first reflected light that is reflected light of the first irradiation light with which the target object T is irradiated, and includes the sensor (second detection unit) 163 to detect the second reflected light that is reflected light of the second irradiation light with which the target object T is irradiated. Further, in the imaging device 10, the first cycle in which the first laser diode 121 emits the first irradiation light and the sensor 153 detects the first reflected light, and the second cycle in which the second laser diode 122 emits the second irradiation light and the sensor 163 detects the second reflected light do not overlap.

Therefore, according to the present embodiment, the imaging device 10 can perform the irradiation and light reception without an interference between reflected light beams of laser light beams with different wavelengths with each other.

Further, according to the embodiment described above, in the imaging device 10, the first cycle is a period within an odd-numbered period of a predetermined cycle, and the second cycle is a period within an even-numbered period of the predetermined cycle. Therefore, the imaging device 10 can easily prevent the near-infrared light beams with the respective wavelengths from interfering with each other by controlling the operation timings of the laser diode light emission and the ToF sensor exposure in alternate frames. Further, since the imaging device 10 controls the operation timings of the laser diode light emission and the ToF sensor exposure in alternate frames, the laser diode light emission and the ToF sensor exposure do not interfere with each other even when the light emission period and the exposure period are elongated.

Further, according to the embodiment described above, in the imaging device 10, the first period is a period within the first cycle, and the second period is a period within the second cycle whose phase is different from the first cycle. That is, according to the imaging device 10, a timing of the emission and exposure of light beams with different wavelengths is set based on respective frame pulse timings, thereby preventing the interference. Therefore, according to the present embodiment, the imaging device 10 can prevent the near-infrared light beams with the respective wavelengths from interfering with each other without decreasing the frame rate.

Further, according to the embodiment described above, in the imaging device 10, the first cycle and the second cycle are the same cycle, and a phase difference between the first cycle and the second cycle is a half cycle. Therefore, according to the present embodiment, the imaging device 10 can easily prevent the near-infrared light beams with the respective wavelengths from interfering with each other by performing emission and exposure for light beams with different wavelengths at timings shifted by half a frame. Further, the imaging device 10 can make the interfere difficult even when the light emission period and the exposure period of the light beams with the respective wavelengths are elongated, by performing emission and exposure for the light beams with different wavelengths at the timings shifted by half a frame.

Further, according to the embodiment described above, in the imaging device 10, the first period within the first cycle is equal to or smaller than half of the first cycle, and the second period within the second cycle is equal to or smaller than half of the second cycle. Therefore, according to the present embodiment, since the first period and the second period do not overlap, it is possible to prevent light beams with different wavelengths from interfering with each other.

According to the imaging device 10A described with reference to FIG. 3, simultaneous distance measurement of 850 [nm] and 940 [nm] cannot be performed, but synchronous control of light emission of the two laser diodes and synchronous control of the two ToF sensor exposures described in Embodiment 2 are unnecessary. Therefore, according to the imaging device 10A, it is possible to obtain best features of both the wavelengths without occurrence of laser diode light interference between the two wavelengths.

### Embodiment 3

Next, Embodiment 3 will be described. An imaging device 10 according to the present embodiment includes a first laser diode (first light source) 121 to emit first irradiation light which is light having a first wavelength, and includes a sensor (first detection unit) 153 detect first reflected light which is reflected light of the first irradiation light reflected by the target object. The first wavelength is, for example, 940 [nm], and is used for outdoor distance measurement.

Further, the imaging device 10 includes a second laser diode (second light source) 122 to emit second irradiation light that is light having a second wavelength different from the first wavelength, and includes a sensor (second detection unit) 163 to detect second reflected light which is reflected light of the second irradiation light reflected by the target object. The second wavelength is, for example, 850 [nm], and is used for indoor distance measurement.

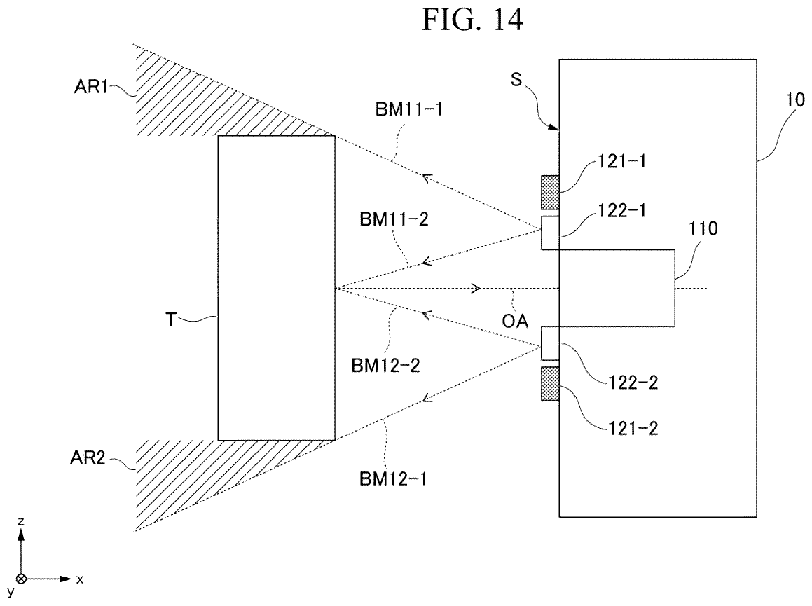

FIG. 14 is a diagram illustrating a problem that the imaging device attempts to solve in Embodiment 3. First, the problem to be solved in Embodiment 3 will be described with reference to FIG. 14.

A plurality of first laser diodes 121 and a plurality of second laser diodes 122 are disposed around a front surface of the lens 110 to surround the lens 110. In the example shown in FIG. 14, a first laser diode 121-1 and a first laser diode 121-2 are disposed as the first laser diode 121, and a second laser diode 122-1 and a second laser diode 122-2 are disposed as the second laser diode 122 to surround the lens 110.

The first laser diode 121 that emits light having a wavelength of 940 [nm] is used for outdoor long-distance use. The second laser diode 122 that emits light having a wavelength of 850 [nm] is used for short distance indoor use.

Here, a distance measurement error due to an angular difference between the optical axis OA of the lens 110 and a laser diode irradiation axis (laser light BM11-2 and laser light BM12-2) becomes a problem. It is preferable to dispose the light source as close to the optical axis OA as possible in order to curb an influence of the distance measurement error at the time of short distance measurement.

Particularly when the target object T is located at a short distance, the influence of the distance measurement error is significant. Further, indoors, the distance to the target object T present at a short distance is often measured as compared to outdoors. Therefore, for the second laser diode 122 used for a short distance, it is preferable for the light source to be disposed at a position close to the optical axis OA as possible in order to reduce the influence of the distance measurement error.

Therefore, the second laser diode (second light source) 122 used for indoor use is preferably located at a position closer to the optical axis OA (near an outer circumferential circle of the lens) than the first laser diode (first light source) 121 used for outdoor use is.

However, when the subject is large, a problem arises in that a shadow from the laser diode irradiation is generated on the side of the subject, and an area where distance measurement cannot be performed increases. In FIG. 14, a range AR1 and a range AR2 are shadow of laser diode irradiation, causing a problem that distance measurement cannot be performed. In Embodiment 3, an attempt is made to prevent such a range where the distance measurement cannot be performed from be generated.

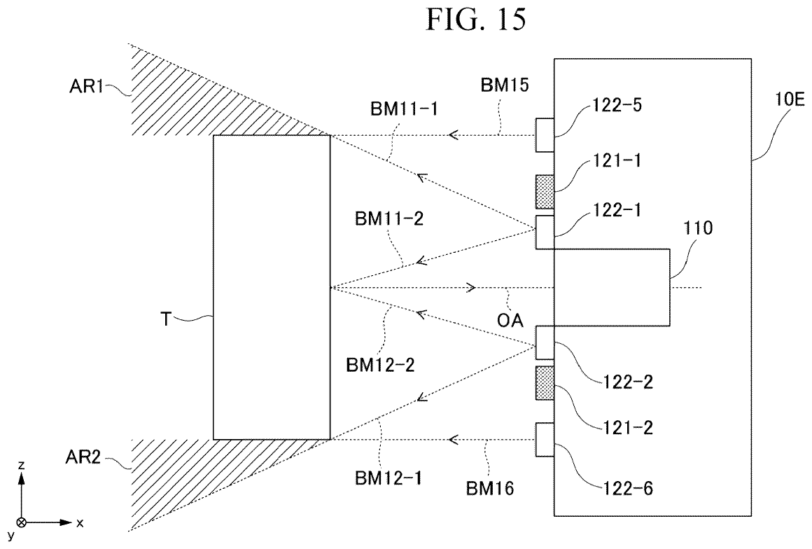

FIG. 15 is a diagram illustrating an example of indoor distance measurement according to Embodiment 3. A functional configuration and effects of an imaging device 10E according to the present embodiment will be described with reference to FIG. 15. In the description of the imaging device 10E, the same components as the functions included in the imaging device 10 may be denoted by the same reference signs and a description thereof may be omitted.

As shown in FIG. 15, the imaging device 10E includes a first laser diode 121 and a second laser diode 122 on a plane S intersecting the optical axis OA. That is, the first laser diode (first light source) 121 and the second laser diode (second light source) 122 are both disposed on a plane intersecting the optical axis OA. Further, a surface S is orthogonal to the optical axis OA. That is, the first laser diode (first light source) 121 and the second laser diode (second light source) 122 are both disposed on the surface perpendicular to the optical axis OA.

The imaging device 10E differs from the imaging device 10 in that the imaging device 10E also includes an 850 [nm] laser diode located far from the optical axis, in addition to the 850 [nm] laser diode included near the optical axis OA. Specifically, the imaging device 10E further includes a second laser diode 122-5 and a second laser diode 122-6.

The imaging device 10E includes the 850 [nm] laser diode not only at a position close to the optical axis but also at a position further away from the optical axis, thereby making it possible to reduce generation of an irradiation shadow. Specifically, the second laser diode 122-5 emits the laser beam BM15 to curb the generation of the irradiation shadow in the range AR1, and the second laser diode 122-6 emits the laser beam BM16 to curb the generation of the irradiation shadows in the range AR2. Since the imaging device 10E can reduce the generation of the irradiation shadow, it can also perform distance measurement for the side of the subject.

The imaging device 10E performs light emission control for each of the laser diodes disposed at two locations (that is, locations near and far from the optical axis). The imaging device 10E can combine two types of distance data (the distance data obtained by the second laser diode 122-1 and the second laser diode 122-2, and the distance data obtained by the second laser diode 122-5 and the second laser diode 122-6) received by the ToF sensor to generate optimized distance data. Further, it is preferable for the imaging device 10E to decrease an emission intensity of the irradiation light emitted from each laser diode in order to prevent signal saturation in the ToF sensor.

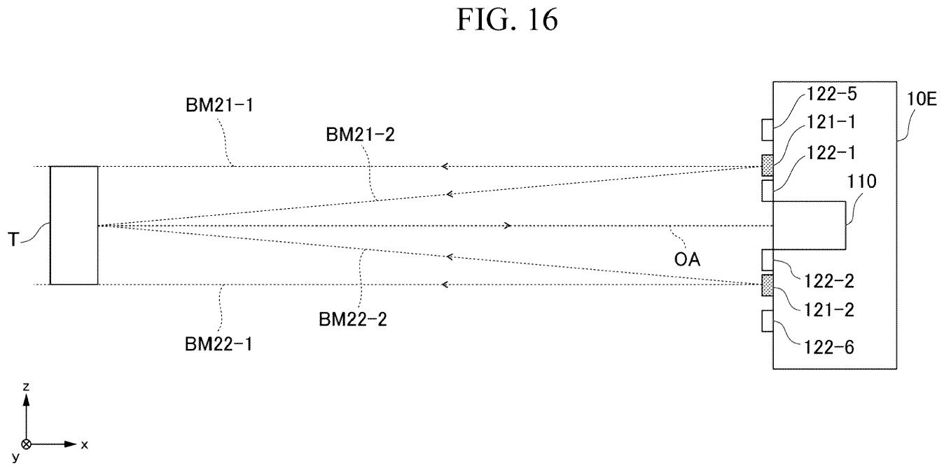

FIG. 16 is a diagram illustrating an example of outdoor distance measurement according to Embodiment 3. An example of outdoor distance measurement in the imaging device 10E according to the present embodiment will be described with reference to FIG. 16. For distance measurement outdoors, the imaging device 10E uses the first laser diode 121. The first laser diode 121 is disposed on the outer side relative to the second laser diode 122. Since the first laser diode 121 is used for distance measurement for medium and long distances, the distance to the target object T is long, and an influence of the distance measurement error due to an angular difference between the lens optical axis OA and the laser diode irradiation axis (laser light BM21-2 and laser light BM22-2) is less. Further, since the distance to the target object T is long, a shadow of the laser diode irradiation is less than at a short distance.

In the imaging device 10E, since the intensity of the signal received by the ToF sensor decreases as a distance to the subject is elongated, it is preferable to increase the emission intensity of the first laser diode 121.

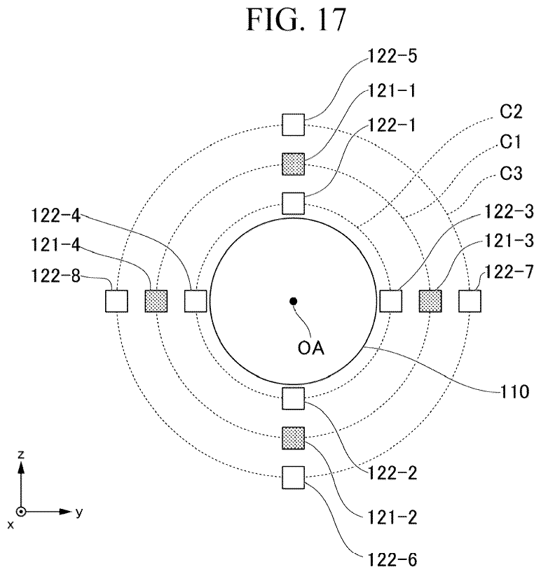

FIG. 17 is a schematic diagram showing an example of the disposition of light sources according to Embodiment 3. An example of the disposition of the first laser diode 121 and the second laser diode 122 will be described with reference to FIG. 17.

In FIG. 17, a positional relationship between the lens 110 and the plurality of laser diodes 120 when the imaging device 10E is viewed from the front is shown.

The imaging device 10E includes a plurality of first laser diodes 121 and a plurality of second laser diodes 122. In an example shown in FIG. 17, four first laser diodes 121 and eight second laser diodes 122 are included.

The plurality of first laser diodes 121 are disposed on a circumference of a first circle C1 centered on the optical axis OA. The plurality of second laser diodes 122 are disposed on the circumferences of the second circle C2 and the third circle C3. The first circle C1 is a circle that has a different radius from the second circle C2 and the third circle C3. Further, the first circle C1, the second circle C2, and the third circle C3 are all concentric circles centered on the common optical axis OA.

The second laser diodes 122-1 to 122-4, which are some of the plurality of second laser diodes 122, are disposed on the circumference of the second circle C2. Further, the second laser diodes 122-5 to 122-8, which are others of the plurality of second laser diodes 122, are disposed on the circumference of the third circle C3. The third circle C3 is a circle having a radius different from both the first circle C1 and the second circle C2, and is a concentric circle centered on the optical axis OA with the first circle C1 and the second circle C2.

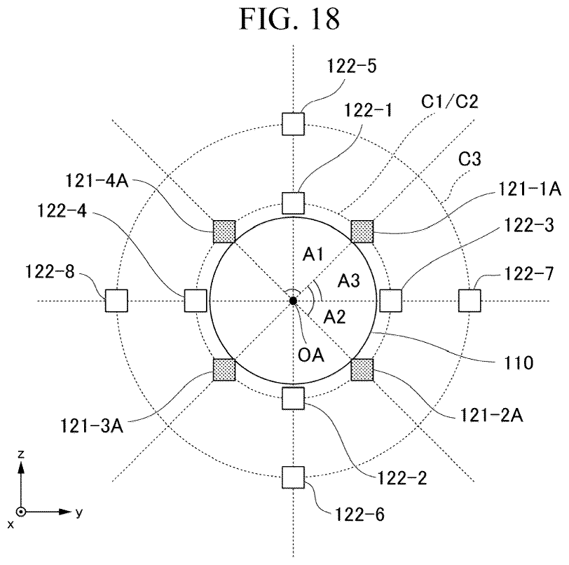

FIG. 18 is a schematic diagram showing an example of the disposition of light sources according to a modification example of Embodiment 3. A modification example of the disposition of the first laser diode 121 and the second laser diode 122 will be described with reference to FIG. 18.

The modification example is different from the example described with reference to FIG. 17 in that the plurality of first laser diodes 121 and some of the plurality of second laser diodes 122 are included on the circumference of the same circle.

In the example shown in FIG. 18, since the second laser diodes 122 are the same as those in the example described with reference to FIG. 17, description thereof may be omitted by denoting the second laser diodes 122 with the same reference signs. On the other hand, since the first laser diodes 121 are disposed differently, the first laser diodes 121 will be described as first laser diodes 121-nA (n is a natural number from 1 to 4).

The first laser diodes 121-1A to 121-4A are disposed on a circumference of the same circle as the second laser diodes 122-1 to 122-4. In other words, in the modification example, the first circle C1 and the second circle C2 are the same circle.

The first laser diodes 121-1A to 121-4A are disposed at each angle A1. The angle A1 is 90 degrees. The second laser diodes 122-1 to 122-4 are disposed at each angle A2. The angle A2 is 90 degrees.

Furthermore, the first laser diodes 121-1A to 121-4A are disposed between the second laser diodes 122-1 to 122-4. The first laser diodes 121-1A to 121-4A and the second laser diodes 122-1 to 122-4 are disposed at angles A3. The angle A3 is 45 degrees.

### Summary of Embodiment 3

According to the embodiment described above, the imaging device 10E includes the first laser diode (first light source) 121 to irradiate the target object T with the first irradiation light which is light having the first wavelength, includes the second laser diode (second light source) 122 to irradiate the target object T with the second irradiation light which is light having the second wavelength, includes the sensor (first detection unit) 153 to detect the first reflected light that is reflected light of the first irradiation light with which the target object T is irradiated, and includes the sensor (second detection unit) 163 to detect the second reflected light that is reflected light of the second irradiation light with which the target object T is irradiated. Further, in the imaging device 10, the second laser diode 122 is disposed at a position closer to the optical axis OA than the first laser diode 121 is. The second laser diode 122 is a light source used for indoor distance measurement.

Therefore, according to the present embodiment, when the imaging device 10E measures the distance to the target object T disposed at a short distance indoors, it is possible to reduce an angular difference between the optical axis OA of the lens 110 and the laser diode irradiation axis. Therefore, the imaging device 10E can reduce the distance measurement error due to the angular difference between the optical axis OA of the lens 110 and the laser diode irradiation axis.

Further, according to the embodiment described above, in the imaging device 10, the first laser diode 121 and the second laser diode 122 are both disposed on the plane intersecting the optical axis OA of the lens 110. Further, the light beams emitted from the first laser diode 121 and the second laser diode 122 are both are incident on the lens 110 on the same optical axis.

Therefore, according to the present embodiment, the sensor 153 and the sensor 163 can share the same lens 110.

Furthermore, according to the embodiment described above, in the imaging device 10, the first laser diode 121 and the second laser diode 122 are both disposed on a surface perpendicular to the optical axis OA of the lens 110. Therefore, when the target object T is present on the optical axis OA, a distance from the first laser diode 121 to the target object T is the same as a distance from the second laser diode 122 to the target object T.

Therefore, according to the present embodiment, the imaging device 10E can accurately measure the distance to the target object T.

Further, according to the embodiment described above, in the imaging device 10, the plurality of first laser diodes 121 are disposed on the circumference of the first circle C1 centered on the optical axis OA of the lens 110, and the plurality of the second laser diode 122 are disposed on the circumference of the second circle C2 which is circle having a radius different from that of the first circle C1 and is a concentric circle centered on the optical axis OA of the lens 110. Therefore, when the target object T is present on the optical axis OA, distances from the plurality of respective first laser diodes 121 to the target object T are the same, and distances from the plurality of respective second laser diodes 122 to the target object T are the same.

Therefore, according to the present embodiment, the imaging device 10E can accurately measure the distance to the target object T.

Further, according to the embodiment described above, in the imaging device 10, some of the plurality of second laser diodes 122 are disposed on the circumference of the second circle C2, and others of the plurality of second laser diodes 122 are disposed on a circumference of a third circle C3 which is a circle having a radius different from both the first circle C1 and the second circle C2 and is a concentric circle centered on the optical axis OA of the lens 110. That is, according to the present embodiment, the second laser diode 122 that measures the distance to the target object T present at a short distance indoors is disposed at each of a position close to the optical axis OA of the lens 110 and a position far from the optical axis OA of the lens 110.

Therefore, according to the present embodiment, the imaging device 10E can curb an influence of the shadow of the target object T caused by the laser light, and accurately measure the distance.

Although the embodiments of the present invention have been described above, the present invention is not limited to the above embodiments, and various changes can be made without departing from the spirit of the present invention, and the above-described embodiments may be combined appropriately.

### INDUSTRIAL APPLICABILITY

According to the present embodiment, it is possible to accurately measure the distance to the target object even in a plurality of different environments. Further, according to the present embodiment, it is possible to measure the distance to the target object using the laser diode light beams with different wavelengths without the interference between the laser diode light beams. Furthermore, according to the present embodiment, it is possible to accurately measure the distance to the target object using the laser diode light beams with different wavelengths.

### REFERENCE SIGNS LIST

10 Imaging device
110 Lens
120 Laser diode
121 First laser diode
122 Second laser diode
130 Half mirror
140 Image capturing unit
141 Visible light reflection dichroic film
142 Infrared cut filter
143 Sensor
144 Pixel
145 Reflection surface
150 Distance measurement unit
152 Band pass filter
153 Sensor
162 Band pass filter
163 Sensor
172 Switching band pass filter
173 Sensor
T Target object
BM Laser light
L Light
VL Visible light
IL Infrared light

What is claimed is:

1. An imaging device comprising:
a first light source configured to emit first irradiation light, the first irradiation light being light having a first wavelength;
a second light source configured to emit second irradiation light, the second irradiation light being light having a second wavelength different from the first wavelength;
a first detection unit configured to detect first reflected light, the first reflected light being reflected light of the first irradiation light with which a target object is irradiated;
a second detection unit configured to detect second reflected light, the second reflected light being reflected light of the second irradiation light with which the target object is irradiated; and
an optical member configured to transmit part of the light reflected by the target object to guide the first reflected light to the first detection unit, and reflect part of the light reflected by the target object to guide the second reflected light to the second detection unit.

2. The imaging device according to claim 1,
wherein the optical member is provided on an optical path between a lens on which the first reflected light and the second reflected light are incident, and the first detection unit and the second detection unit, and
the first reflected light and the second reflected light pass through substantially the same optical axis between the lens and the optical member.

3. The imaging device according to claim 2, further comprising:
a third detection unit configured to detect visible light; and
a visible light reflection film configured to transmit the first reflected light and the second reflected light incident on the lens to guide the first reflected light to the first detection unit and the second reflected light to the second detection unit, and reflect the visible light incident on the lens to guide the visible light to the third detection unit.

4. The imaging device according to claim 3,
wherein the visible light reflection film is provided on an optical path between the lens and the optical member, and
the visible light passes through substantially the same optical axis as the first reflected light and the second reflected light between the lens and the visible light reflection film.

5. An imaging device comprising:
a first light source configured to emit first irradiation light, the first irradiation light being light having a first wavelength;
a second light source configured to emit second irradiation light, the second irradiation light being light having a second wavelength different from the first wavelength;
a first detection unit configured to detect first reflected light, the first reflected light being reflected light of the first irradiation light with which a target object is irradiated; and
a second detection unit configured to detect second reflected light, the second reflected light being reflected light of the second irradiation light with which the target object is irradiated, wherein
a first period in which the first light source emits the first irradiation light and the first detection unit detects the first reflected light does not overlap a second period in which the second light source emits the second irradiation light and the second detection unit detects the second reflected light.

6. The imaging device according to claim 5, wherein the first period and the second periods are periods that occur alternately at a predetermined time interval.

7. The imaging device according to claim 5, wherein
the first period is a period with a first cycle, and
the second period is a period with a second cycle whose phase is different from that of the first period.

8. The imaging device according to claim 7, wherein a phase difference between the first cycle and the second cycle is half a cycle.

9. An imaging device comprising:
a first light source configured to emit first irradiation light, the first irradiation light being light having a first wavelength;
a second light source configured to emit second irradiation light, the second irradiation light being light having a second wavelength different from the first wavelength;
a first detection unit configured to detect first reflected light, the first reflected light being reflected light of the first irradiation light with which a target object is irradiated; and
a second detection unit configured to detect second reflected light, the second reflected light being reflected light of the second irradiation light with which the target object is irradiated, wherein
the second light source is disposed at a position closer to the optical axis than the first light source is.

10. The imaging device according to claim 9, wherein the first light source and the second light source are both disposed on a plane intersecting the optical axis.

11. The imaging device according to claim 9,
further comprising:
a plurality of the first light sources; and
a plurality of said second light sources, wherein
the plurality of second light sources are disposed at positions closer to the optical axis than any of the first light sources is.
